(19) United States
(12) Patent Application Publication
(10) Pub. No.: US 2009/0319366 A1
(43) Pub. Date: Dec. 24, 2009

(54) SYSTEM AND METHOD FOR MANAGING SHARED/FORWARDED ADVERTISEMENT

(75) Inventors: Seok-Hoon CHOI, Seongnam-si (KR); Hae-Young Jun, Anyang-si (KR); Ji-Hye Lee, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/488,015

(22) Filed: Jun. 19, 2009

(30) Foreign Application Priority Data
Jun. 19, 2008 (KR) 10-2008-0058078
Jun. 20, 2008 (KR) 10-2008-0058647
Sep. 11, 2008 (KR) 10-2008-0089965
Oct. 29, 2008 (KR) 10-2008-0106711

(51) Int. Cl. G06Q 30/00; G06F 15/16

(52) U.S. Cl. 705/14.45; 705/14.49; 705/14.55; 709/206

(57) ABSTRACT

The function of managing delivery information of ad sharing/forwarding in a server is implemented. For this, disclosed is a method of providing delivery information of an ad to a server when a user who has received the ad delivers the ad to another user. The method of providing delivery information differs when the user delivers the ad to another user through a server and when the user directly delivers the ad to another user without passing it through the server. According to the method, the server can easily track the situation of an ad delivery, and thus effectively confirms the changing particulars of an ad and performs billing appropriation and ad effect measurement.

### PRIORITY

This application claims priority under 35 U.S.C. §119(a) to applications entitled “System And Method For Managing Shared/Forwarded Advertisement” filed in the Korean Industrial Property Office on Jun. 19, 2008, Jun. 20, 2008, Sep. 11, 2008 and Oct. 29, 2008 and assigned Serial Nos. 10-2008-0058078, 10-2008-0058647, 10-2008-0089965, and 10-2008-0106711, respectively, the contents of each which are incorporated herein by reference.

### BACKGROUND OF THE INVENTION

1. Field of the Invention

The present invention relates generally to a mobile advertising system for providing custom mobile advertising (hereinafter MobAd) service which discriminates users, and more particularly to a method and a system for managing advertisements when a user delivers a received advertisement to another user through a mobile advertising system.

2. Description of the Related Art

Open Mobile Alliance (hereinafter OMA) is an organization that studies the standards for interaction of individual mobile solutions and determines diverse application standards for mobile communication games, internet services, and the like. In particular, among OMA working groups, OMA REQ (Open Mobile Alliance Requirement Working Group) and OMA CD (Open Mobile Alliance Content Delivery Working Group) have studied the technical standards for MobAd.

According to such MobAd service technology, a user intending to receive a custom ad transmits such user profile information as the user's preference and context information about the terminal, to a server of a MobAd service provider (hereinafter SP). Then, the server selects the user's content and an ad, which are suitable for corresponding criteria that satisfies the user preference of the user profile and context information received from the user, among content received from a content provider (hereinafter CP) and an ad received from sponsors, and delivers the selected content and the ad to the user of the terminal to provide a discriminated custom ad service.

FIG. 1 illustrates a conventional ad delivery process from a server to a client. In FIG. 1, first client 10 and second client 30 represent ad-engines which are names of objects defined in MobAd of OMA, and server 20 represents MobAd entities on the network.

Referring to FIG. 1, the server 20 delivers an ad to the first client 10 in step 100. If the ad is received normally, the first client 10 transmits an ad response to the server 20 in step 105. Then, the first client 10 performs interaction such as access to services provided in the ad by the terminal user in step 110. Accordingly, the metrics are then transmitted to the server 20 in step 115, and are transmitted to the server 20 periodically or when it is requested by the server 20. The server 20 stores the received metrics in step 120, and then transmits a metrics response to the first client 10 in step 125. The first client 10, as in step 130, can transmit the ad that the first client has, to a second client 30. In this case, the first client may receive an ad response from the second client, and such ad response may be omitted. Then, the second client 30 performs interaction in accordance with the ad reception in step 140.

As described above, the ad transmitted to a specified user may be delivered to another user, such as the user's friend or an acquaintance, by sharing/forwarding the ad. In this case, it is required for the server to always recognize that the sharing/forwarding state of the corresponding ad or of the impression state of the shared/forwarded ad has been changed. Accordingly, the server can measure the ad effect of the corresponding ad and appropriate the billing with reference to the changing particulars. However, according to the conventional MobAd service technology, such function cannot be implemented, and a method for solving this is required.

Accordingly, there is a need for a method for causing the server to constantly recognize the sharing/forwarding particulars of the corresponding ad and the changing particulars occurring later when a specified user delivers the received ad to another user for the sharing/forwarding thereof.

### SUMMARY OF THE INVENTION

The present invention provides a system and a method for systematically and efficiently managing an advertisement when a user having received the advertisement delivers the advertisement to another user for sharing/forwarding.

The present invention provides a system and a method for enabling a server to always trace the status of a corresponding shared/forwarded advertisement and the changing particulars of the advertisement occurring later.

In accordance with the present invention, there is provided a client method for sharing a shared/forwarded ad in an ad management system including at least one client, and a server, the client method including receiving an ad data from the server; determining a particular one of the plurality of clients to be provided the received ad data; and delivering a request message to the server, the request message including information of the received ad data and an identification of the particular client, wherein the server transmits the ad data to the another client according to the request message.

In accordance with the present invention, there is provided a client method for managing a shared/forwarded advertisement (ad) in an ad management system including at least one client and a server, the client method comprising: receiving an ad data from the server; delivering directly information of the received ad data to an another client ; and delivering a message to notify to the server whether delivering the received ad data to the another client.

In accordance with the present invention, there is provided a server method for providing a shared/forwarded advertisement (ad) in an ad management system including a plurality of clients and a server, the server method comprising: transmitting an ad data to a particular client receiving a request message from the particular client, the request message including information about ad delivery to deliver a received ad data; storing the information about the ad delivery from the request message, and transmitting a response message corresponding to the request message to the particular client; transmitting the corresponding ad using the information to another client.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a conventional ad delivery process from a server to a client;

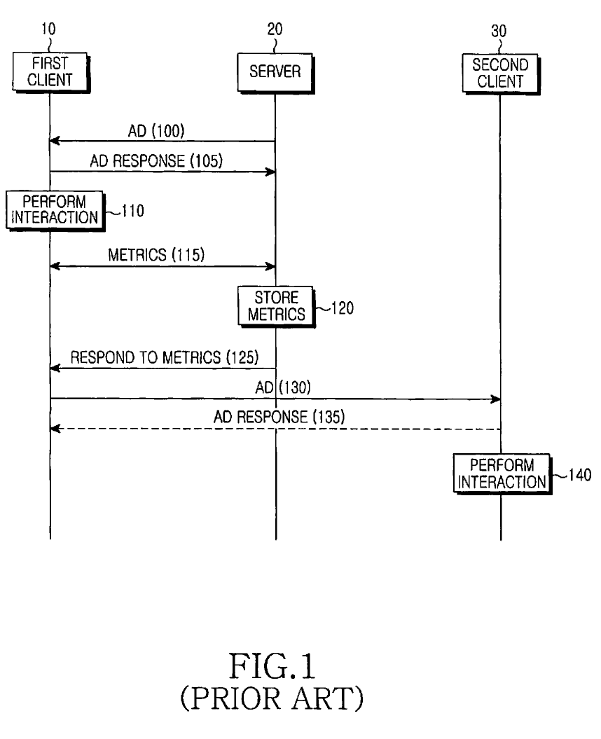

FIG. 2 illustrates an ad management system according to the present invention;

FIG. 3 illustrates an ad sharing/forwarding from the first client to the second client through the server according to a first embodiment of the present invention;

FIG. 4 illustrates that the second client provides ad delivery information to the server during ad delivery without passing it through a server according to a second embodiment of the present invention;

FIG. 5 illustrates that the first client provides ad delivery information to the server during ad delivery without passing it through a server according to a second embodiment of the present invention; and

FIG. 6 illustrates the ad delivery using an ad report according to a third embodiment of the present invention.

### DETAILED DESCRIPTION OF THE PREFERRED EMBODIMENTS

Hereinafter, preferred embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted for the sake of clarity and conciseness.

The present invention implements the function of managing the delivery information of ad sharing/forwarding in a server. For this, the present invention discloses a method of providing delivery information of an ad to a server when a user who has received the ad delivers the ad to another user. In this case, the method of providing delivery information differs in accordance with when the user delivers the ad to another user through a server and when the user directly delivers the ad to another user without passing it through the server. According to the present invention, the server can easily track the situation of the ad delivery, and thus can effectively confirm the changing particulars of the ad and perform billing appropriation and ad effect measurement.

In the following description, names of objects defined in MobAd of 3GPP (3^{rd} Generation Partnership Project) that is the 3^{rd} generation mobile communication standard or OMA that is the mobile terminal application standard organization will be used. However, such standards and names do not limit the scope of the present invention, and can be applied to systems having similar technical backgrounds.

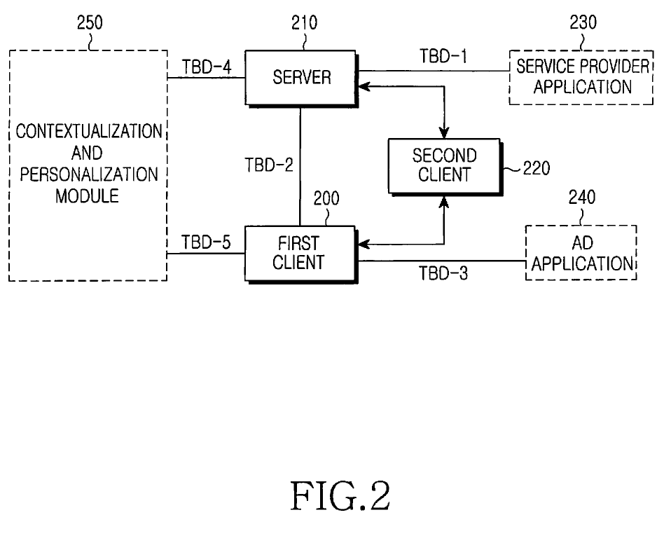

FIG. 2 illustrates the elements constituting the ad management system and interfaces according to the present invention. Referring to FIG. 2, the ad management system roughly includes an ad-engine and MobAd entities on the network. The ad-engine corresponds to a first client 200 or a second client 220, and the MobAd entities correspond to a server 210.

The first client 200 is positioned in a terminal, and is used to access the server 210. The second client 200 is a functional group composed of logical modules, and accesses the server 210 using the TBD (To Be Determined)-2 interface. The first client 200 performs interaction with many different ad applications 240. The ad application 240 supports useful functions capable of accessing MobAd services through the first client 200, and uses the TBD-3 interface for communications with the first client 200. In addition, the first client 200 exchanges service management information with the server 210, and performs functions such as reception of a proper ad from the server 210, management of a received ad, selection of an ad from terminal storage, ad-related feedback to the server 210 and filtering.

The server 210 provides application based network functions for the MobAd services. The server 210 exchanges service management information with the first client 200, and provides an ad and ad notification to the first client 200. Between the server 210 and a service provider application 230 providing MobAd, the TBD-1 interface is used. Contextualization and personalization module 250 serves to provide user operation information such as position information and preference, to the server 210. The contextualization and personalization module 250 communicates with the server 210 using the TBD-4 interface, and communicates with the client 200 using the TBD-5 interface.

The ad management system as constructed above further includes the second client 220, which is mounted on a terminal on which the first client 200 is not mounted, and provides functions for providing MobAd service in the same manner as the first client 200.

According to the first embodiment of the present invention, the first client 200 delivers an ad for sharing/forwarding to the second client 220. The first client 200 requests ad delivery for the sharing/forwarding from the server. For this, an ad share/forward request message may be used. Examples of such a message will be described below. In response to the request, the server 210 stores the delivery information, and then transmits the corresponding ad to the second client 220. The ad transmitted to the second client 220 may be included in a request message from the first client 200 or an ad provided by the server 210.

According to the second embodiment of the present invention, the first client 200 directly delivers the ad for the sharing/forwarding to the second client 220 without passing it through the server 210. Then, the first client 200 informs the server 210 of the situation for the ad delivery by using the ad sharing/forwarding request message. In this case, the second client having received the ad, instead of the first client 200, may inform the server 210 of the situation for the ad delivery by using the ad sharing/forwarding request message.

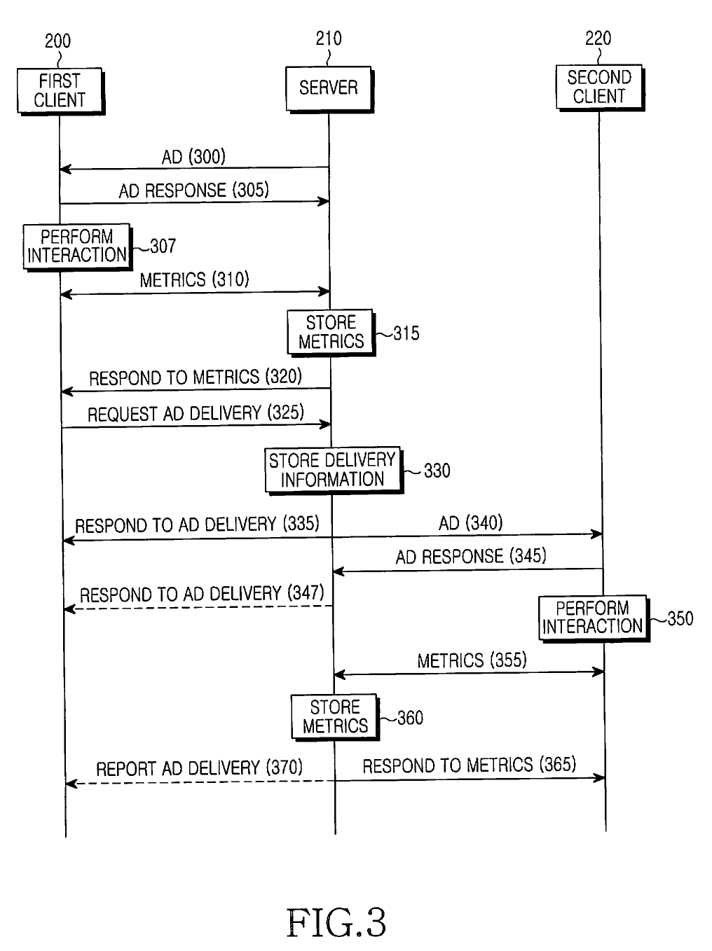

FIG. 3 illustrates an ad sharing/forwarding process from the first client to the second client through the server according to the first embodiment of the present invention.

Referring to FIG. 3, the first client 200 that is a terminal intending to share/forward the ad according to the first embodiment, receives the ad according to the MobAd service from the server 210 in step 300. The first client 200 having received the ad transmits an ad response to the server 210 in step 305. The first client 200 performs interaction, such as access of the service provided in the ad by the terminal user, in step 307, stores whether to perform interaction for the ad of the terminal user, and then provides user's metrics for the corresponding ad in step 310. The metrics may be transmitted to the server 210 periodically, for a given period, or when requested by the server 210. The server 210 stores the received metrics in step 315, and then transmits a metrics response to the first client 200 in step 320. Steps 310 to 320 may be performed between steps 325 to 370 or after step 370.

A user of a terminal on which the first client 200 is mounted intends to provide the currently received ad to a user of a terminal on which the second client 220 is mounted. In order to transmit the ad to the second client 220, the first client 200 first requests ad delivery for the sharing/forwarding from the server 210 in step 325. For such requests for ad delivery, an ad share/forward request message may be used. As an example, the ad share/delivery request message may be as shown in Table 1. However, the table does not limit the shape of the message.

The term “cardinality” in Table 1 represents the number of existing items defined in the term “Name,” and category items are mandatory/optional support of items defined in the name item.

TABLE 1

| Name | Type | Category | Cardinality | Description | Data Type |
|---|---|---|---|---|---|
| Ad- | A | M | 1 | ID of the Ad- | anyURI |
| Share/Forward- | | | | Share/Forward-Request | |
| Request-ID | | | | Message, globally | |
| | | | | unique | |
| Version | A | O | 1 | Version of the Ad- | unsignedInt |
| | | | | Share/Forward-Request. | |
| | | | | The newer version | |
| | | | | overrides the older one. | |
| Type | A | M | 1 | Type of the Ad- | string |
| | | | | Share/Forward-Request | |
| | | | | 1. Sent by user who | |
| | | | | wants to share/forward | |
| | | | | the ad | |
| | | | | 2. Sent by user who | |
| | | | | received the | |
| | | | | shared/forwarded ad | |
| User-ID | A | M | 1 | ID of user who wants to | anyURI |
| | | | | share/forward the ad | |
| Name | A | M | 1 . . . N | Specify the name of user | string |
| | | | | who wants to | |
| | | | | share/forward the ad, | |
| | | | | possibly in multiple | |
| | | | | languages | |
| Target- | A | O | 1 . . . N | Specify the list of users | string |
| Users | | | | whom the service is | |
| | | | | targeting at (e.g. name, | |
| | | | | telephone number, e- | |
| | | | | mail, etc) | |
| Advertisement | A | M | 0 . . . N | The advertisement or | |
| or Ad- | | | | Ad-Metadata that will be | |
| Metadata | | | | shared/forwarded | |

In Table 1, “Ad-Share/Forward-Request-ID” is an item allocated to identify the type of message sent to the server. “Version” indicates the version of the ad share/forward request message, and is used to replace the previous ad share/forward request message when the server receives a new ad share/forward request message, or to delete the received message without storing it when the version of the received message is older than that of the current ad share/forward request message.

“Type” represents the subject that has transmitted the Ad-Share/Forward-Request message, and is used to determine whether the request has been made by the user who has intended to deliver the ad or the user who has received the ad. “User ID” represents the ID of the user who wants to share/forward the ad or the ID of the user terminal. The “User ID” may be used to call the user terminal for further ad transmission if the user ID is required in judging the legality of the ad retransmission request or if the server is unable to transmit the ad immediately when the client requests the message transmission since the user terminal receives the MobAd service through a broadcasting channel.

“Name” is the name of the user who requests the ad delivery, and may be inscribed in multiple languages. “Target-Users” represents the users who share/forward the ad delivery. “Advertisement or Ad-Metadata” represents an ad to be shared/forwarded or metadata of the ad. In the “Advertisement or Ad-Metadata” item, one or several ads to be delivered are inserted in the form of a Multipurpose Internet Mail Extension (MIME) or one or several ad metadata are inserted to inform the server what is the delivered ad so that the server can deliver the ad that the server has to the opposite party. The “Ad-Metadata” follows the definition recited in the OMA MobAd requirement document.

As described above, the request for the ad delivery may be delivered to the server 210 through a separate ad share/forward request message. In another embodiment of the present invention, however, the ad delivery request can be delivered when the first client 200 provides the metrics for the corresponding ad to the server 210 in the step 310. In this case, information described in Table 1 can also be delivered to the server 210 together with the metrics.

If the ad share/forward request message as described above is received, the server extracts and stores the delivery information included in the message in step 330. For this, the server 210 transmits an ad response to the first client in response to the received request message in step 335. An ad share/forward response message may be used for such an ad response. As an example, the ad share/delivery request message may be as shown in Table 2. However, the table does not limit the shape of the message.

TABLE 2

| Name | Type | Category | Cardinality | Description | Data Type |
|---|---|---|---|---|---|
| Ad- | A | M | 1 | ID of the Ad- | anyURI |
| Share/Forward- | | | | Share/Forward-Response | |
| Response- | | | | Message, globally | |
| ID | | | | unique | |
| Ad- | A | M | 1 | ID of the Ad- | anyURI |
| Share/Forward- | | | | Share/Forward-Request, | |
| Request-ID | | | | globally unique | |
| Status | A | M | 1 | The overall outcome of | string |
| | | | | the received message | |
| | | | | such as error conditions | |
| | | | | corresponding to the | |
| | | | | request | |
| Advertisement | A | O | 0 . . . N | The advertisement or | |
| or Ad- | | | | Ad-Metadata that will be | |
| Metadata | | | | shared/forwarded | |

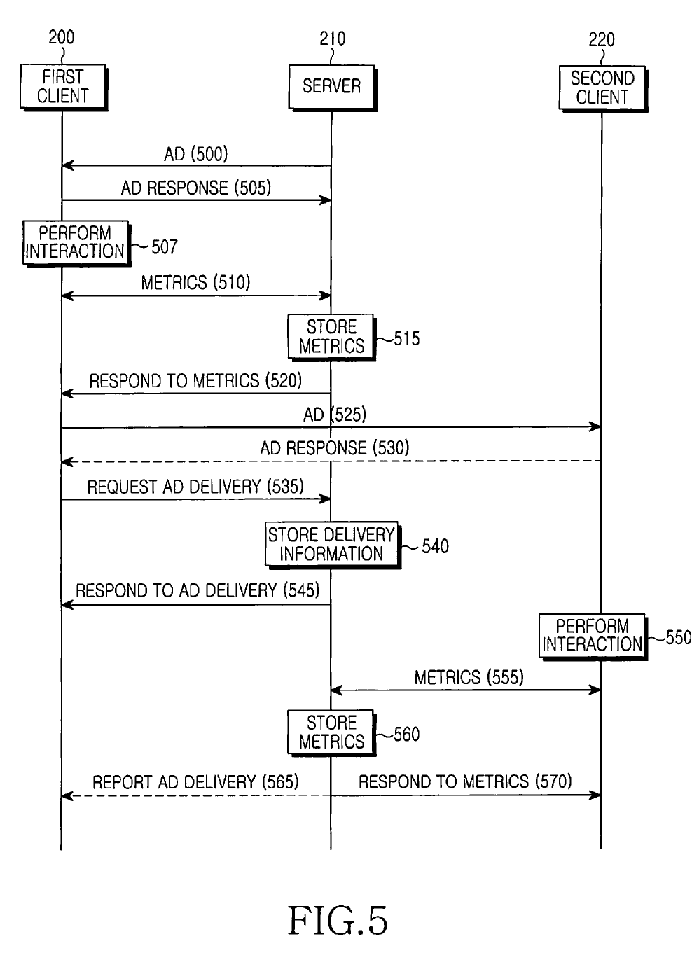

In Table 2, “Ad-Share/Forward-Response-ID” is allocated to identify the type of message that the server sends to the client, having requested the ad share/forward, in response to the ad share/forward request message. That is, “Ad-Share/Forward-Response-ID” indicates that the corresponding message is a response to the request message. “Ad-Share/Forward-Request-ID” is the same as that described in Table 1, and “Status” represents status information, such as transmission success, failure and reason for failure, of the ad share/forward request message. “Advertisement or Ad-Metadata” is ad metadata of the ad to be shared/forwarded or the ad metadata of the shared/forwarded ad. “Ad-Metadata” is transmitted by the server to identify the shared/forwarded ad when the ad, of which sharing/forwarding has been requested by the first client 200, is reported, and “Advertisement” is an item allocated for the server to deliver the ad to the second client, to which the ad has been shared/forwarded, when the second client receives the ad metadata that is not the ad. This item is required in FIG. 5 as described below.

After transmitting the ad response to the first client 200, the server 210 confirms from whom the request has been received by confirming “Type” among transfer information extracted from the ad share/forward request message. Also, the server confirms which ad is to be delivered by confirming the actual ad or ad metadata inserted in the “Advertisement or Ad-Metadata” item among the extracted transfer information. Accordingly, the server transfers the ad to the second client 220 in step 340. If the actual ad is included in the ad share/forward request message, the server 210 transmits the ad in the message to the second client 220. Also, if the ad metadata is included in the ad share/forward request message, the server 210 searches for the ad corresponding to the ad metadata among the ads provided by the server, and transmits the searched ad to the second client 220. The server 210 confirms the object to which the ad is to be delivered by confirming “Target-Users” among the extracted delivery information. By doing this, the terminal user mounting the second client 220 thereon can use the same ad as that in the first client 200.

However, the second client 220, having received the ad from the server 210, transmits an ad response to the server 210 in response to the received ad in step 345. In this case, the server 210 may transmit the ad response to the first client 200 in advance as in the step 335, or may transmit the ad response to the first client 200 after receiving the ad response from the second client 220 as in step 347. In accordance with the ad reception, the second client 220 operates in the same manner as the first client 200. Since the operation in steps 350 to 365 is the same as the operation in the steps 307 to 320, the detailed description thereof will be omitted for the sake of conciseness. By doing this, the server can be aware of not only the ad changing particulars but also the ad response particulars on the basis of the metrics of the second client 220. Accordingly, the server 210 provides to the first client 200 information on benefits that the user of the first client 200 can receive on the basis of the ad response particulars of the second client 220 in step 370.

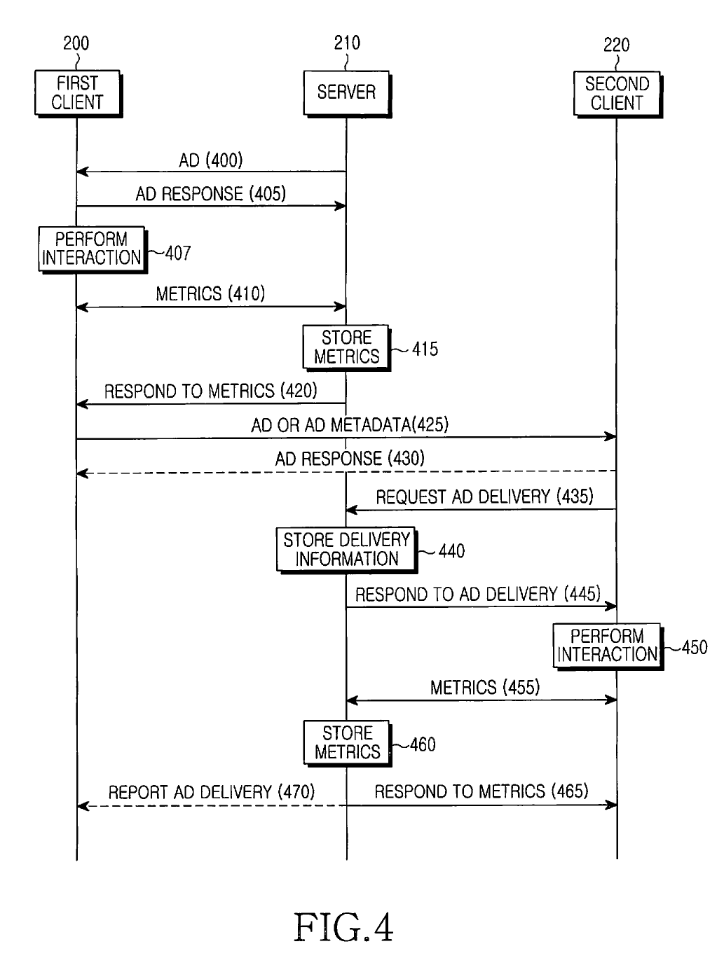

FIGS. 4 and 5 illustrate the case where a client mounted on a terminal that intends to share/forward an ad directly delivers the ad to a client of another terminal without passing it through a server according to the second embodiment of the present invention. In particular, FIG. 4 illustrates a process in which the first client 200 delivers the ad to the second client 220, and in response the second client 220 provides information about the ad delivery to the server 210. FIG. 5 illustrates a process in which the first client 200 provides the information about the ad delivery to the server after the ad delivery.

Referring to FIG. 4, since steps 400 to 420, which are performed as the first client 200 receives the ad of the MobAd service from the server 210, are the same as steps 300 to 320 as illustrated in FIG. 3, the detailed description thereof will be omitted for the sake of conciseness. When providing the ad to another user, the first client 200 can directly deliver the ad to a desired opposite party without passing it through the server. FIG. 4 illustrates the case where the first client 200 delivers the ad to the second client 220. As in step 425, the first client 200 can directly deliver the ad or the ad metadata to the second client 220. In delivering the ad to the second client 220 directly, diverse one-to-one (1:1) communication methods, such as local-area wireless communications and sharing of a storage medium in which the ad is stored, may be used. If the first client 200 requests the ad response, the second client 220 delivers the ad response to the first client 200 as in step 430.

Thereafter, in order to receive the benefits according to the use of the corresponding ad service, the second client 220 transmits an ad delivery request to the server 210 in step 435. That is, the second client 220 informs the server 210 that the first client 200 and the second client 220 have the ad or the ad metadata. For such an ad delivery request, an ad share/forward request message that includes information as described in Table 1 is used. For example, the ad share/forward request message may be, but is not limited to, that as shown in Table 1.

In particular, the “Type” item of the ad share/forward request message represents that the corresponding message is sent by the user who has received the ad, and for example, corresponds to the identification entry no. 2 of “Description” of the “Type” item. Also, when receiving the ad in step 425, it is enough for the second client 220 to inform the server 210 of the ad received by the second client 220 without the necessity of delivering the actual ad, and metadata including the identification of the ad may be included in the “Advertisement or Ad-Metadata” item. In the “Target-Users” item for informing the server that the user who will receive the benefits according to the use of the corresponding ad service is the second client 220, information about the second client 220 is inserted.

Upon receiving the message, the server 210 stores delivery information from the message in step 440, and transmits the corresponding ad response to the second client 220 in step 445. An ad share/forward response may be used as the ad response. If the second client 220 receives the ad metadata instead of the ad in step 425, the server 210, having received the message, transmits the ad response including the ad to the second client 220 in step 445. The corresponding ad may be included in the “Advertisement or Ad-Metadata” item of the message as shown in Table 2, or may be directly delivered from the server 210 as in steps 340 to 345 of FIG. 3. By doing this, the second client 220 can inform the server 210 of the ad changing particulars. Then, the second client 220 can use the ad from the first client 220, and thus performs the interaction such as access to services provided in the ad by the user in step 450. The operations in steps 450 to 470 following the interaction are the same as those in the steps 350 to 370 as shown in FIG. 3, so the detailed description thereof will be omitted for the sake of conciseness.

However, if the second client 220 receives the actual ad in step 425, it may not deliver the ad share/forward request message in a separate step such as step 435, but may provide the information delivered by the ad share/forward request message when it provides the metrics for the corresponding ad to the server 210. For example, when the second client 220 provides the metrics for the corresponding ad to the server 210, it may transmit the ad share/forward request message as well in step 455.

As described above in FIG. 4, after receiving the ad from the first client 200, the second client 220 provides the information according to the ad reception to the server 210. In this case, the first client 200 may provide the information according to the ad delivery to the server 210 after it delivers the ad to the second client 220. FIG. 5 illustrates when the first client 200 provides the information according to the ad delivery to the server 210.

In FIG. 5, a process in which the first client 200 directly delivers the ad for the sharing/forwarding to the second client 220 is the same as the ad delivery process in FIG. 4, and thus steps 500 to 530 are the same as those in steps 400 to 430 in FIG. 4. Although FIG. 5 illustrates the case where step 525 delivers only the ad, the ad or ad metadata can be delivered in the same manner as step 425 in FIG. 4. In the case of delivering only the ad metadata to the second client 220, not illustrated in FIG. 5, a process in which the server 210 directly delivers to the second client 220 the ad corresponding to the ad metadata as in the operations in the steps 340 to 345 in FIG. 3, may be added.

Also, steps 550 to 570 after the second client 220 performs the interaction for the received ad are the same as those in steps 450 to 470 in FIG. 4. However, in FIG. 5, the first client 200 informs the server 210 of the information according to the ad delivery, and for this, it transmits the ad delivery request to the server 210 in step 535. An ad share/forward request message that includes information as described in Table 1 is used. In this case, the “Type” item of the ad share/forward request message represents that the corresponding message is delivered by the user who desires the ad sharing/forwarding, and for example, corresponds to the identification entry no. 1 of “Description” of the “Type” item. Accordingly, the server 210 stores the information included in the message in step 540, and transmits a response corresponding to the message reception to the first client 200. For such a response, an ad share/forward response message that includes information as described in Table 2 is used.

Steps 510 to 520, which correspond to a process of providing the first client's metrics for the ad to the server 210 may be performed after steps 525 to 530 in which the first client 200 directly delivers the ad or the ad metadata to the second client 220. The first client 200 does not transmit a separate ad share/forward request message as in step 535, but provides the information intended to be delivered using the ad share/forward request message when the first client 200 provides the metrics for the corresponding ad to the server 210 in step 510. For example, the first client 200 transmits the ad share/forward request message together with the metrics for the corresponding ad to the server 210 instep 510.

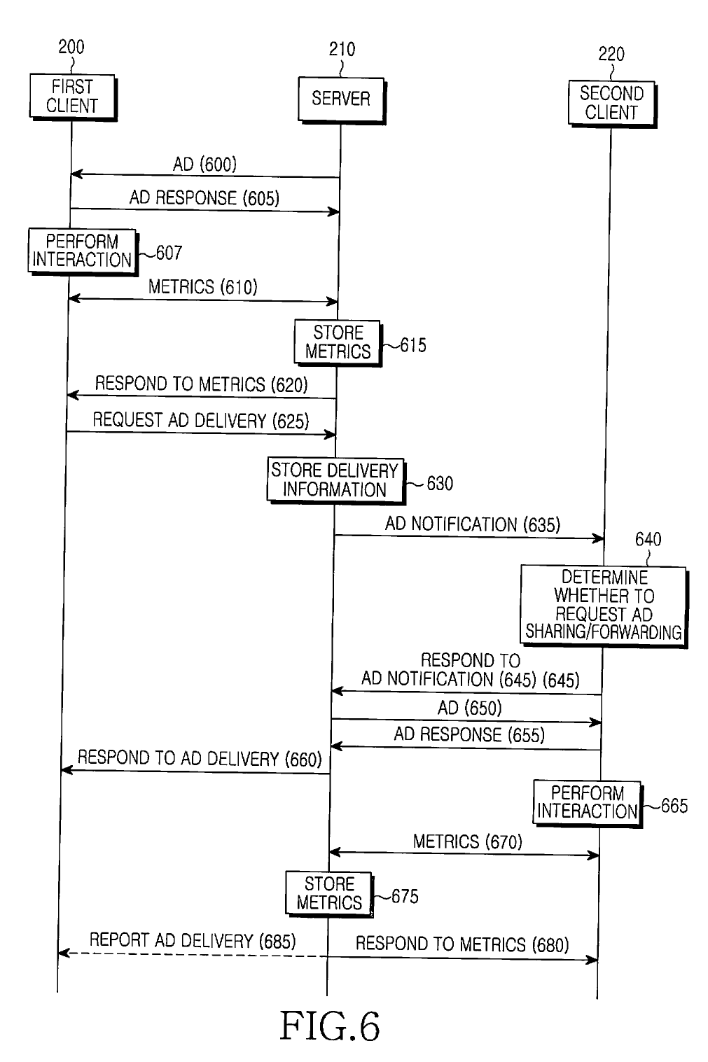

Although FIG. 3 illustrates that the server unilaterally pushes the ad to the second client in response to the first client's request, it may also be considered that the server pulls the ad. FIG. 6 illustrates the case where the server informs the second client that an ad is to be delivered, and then determines whether to deliver the ad in accordance with a response from the second client.

In FIG. 6, steps 600 to 630 that correspond to a process in which the first client 200 requests the ad delivery to the server are the same as those in the steps 300 to 330 in FIG. 3.

Then, the server 210 informs the second client 220 that there is an ad which the first client 200 intends to share/forward. An ad notification message may be used to inform the second client of such ad sharing/forwarding. As an example, the ad notification message may be as shown in Table 3. However, the table does not limit the shape of the message.

TABLE 3

| Name | Type | Category | Cardinality | Description | Data Type |
|---|---|---|---|---|---|
| Ad- | A | M | 1 | ID of the Ad- | anyURI |
| Notification- | | | | Notification Message, | |
| ID | | | | globally unique | |
| Version | A | O | 1 | Version of the Ad- | unsignedInt |
| | | | | Notification. The | |
| | | | | newer version overrides | |
| | | | | the older one. | |
| User-ID | A | M | 1 | ID of user who wants to | anyURI |
| | | | | share/forward the ad | |
| Name | A | M | 1 . . . N | Specify the name of | string |
| | | | | user who wants to | |
| | | | | share/forward the ad, | |
| | | | | possibly in multiple | |
| | | | | languages | |
| Advertisement | A | M | 0 . . . N | Information about | |
| or Ad- | | | | Advertisement or Ad- | |
| Metadata | | | | Metadata that will be | |
| Information | | | | shared/forwarded (e.g. | |
| | | | | title, genre and etc.) | |

In Table 3, “Ad-Notification-ID” is an item allocated to identify the type of message sent to the client to which the ad is to be shared/forwarded. “Version” indicates the version of the ad notification message, and is used to replace the previous ad notification message when the server receives a new ad notification message, or to delete the received message without storing it when the version of the received message is older than that of the current ad notification message.

“User ID” represents the ID of the user who wants to share/forward the ad or the ID of the user terminal, and may be used to call the user terminal for further ad transmission if the user ID is required in judging the legality of the ad retransmission request or if the server is unable to transmit the ad immediately when the client requests the message transmission since the user terminal receives the MobAd service through a broadcasting channel.

“Name” is the name of the user who requests the ad delivery, and may be inscribed in multiple languages. “Advertisement or Ad-Metadata Information” represents an ad to be shared/forwarded or information about ad metadata (e.g. title, contents and genre of the ad). In the “Advertisement or Ad-Metadata Information” item, several ads or ad metadata may be included. The “Ad-Metadata Information” follows the definition recited in the OMA MobAd requirement document.

In step 640, the user of the second client 220, having received the ad notification message, confirms the sender and information about the shared/forwarded ad, and determines whether to request the ad sharing/forwarding. The request for the ad sharing/forwarding may be performed in accordance with the presetting in the second client 220.

In step 645, the second client 220 notifies the server 210 of a response to the ad notification. That is, the second client 220 can notify the server 210 of the ad share/forward request in response to the ad notification. For the ad share/forward request, an ad notification confirmation message may be used. As an example, the ad notification confirmation message may be as shown in Table 4. However, the table does not limit the shape of the message.

TABLE 4

| | | | | | Data |
|---|---|---|---|---|---|
| Name | Type | Category | Cardinality | Description | Type |
| Ad- | A | M | 1 | ID of the Ad- | anyURI |
| Notification- | | | | Notification- | |
| Confirmation- | | | | Confirmation Message, | |
| ID | | | | globally unique | |
| Ad- | A | M | 1 | ID of the Ad- | AnyURI |
| Notification- | | | | Notification Message, | |
| ID | | | | globally unique | |
| Status | A | M | 1 | The overall outcome of | String |
| | | | | the received message | |
| | | | | such as error conditions | |
| | | | | corresponding to the | |
| | | | | request | |

In Table 4, “Ad-Notification-Confirmation-ID” is allocated to identify the type of message that the client sends to the server in order to request the notified shared/forwarded ad in response to the ad notification message. That is, “Ad-Notification-Confirmation-ID” is the same as that as described above with reference to Table 3, and “Status” represents status information, such as transmission success, failure and reason for failure, of the ad notification message.

On the basis of the response to the ad notification, the server 210 can deliver the ad to the second client 220 in step 650. Accordingly, the second client 220 transmits an ad response to the server 210 corresponding to the ad reception in step 655. Steps 650 and 655 are the same as steps 340 and 345 in FIG. 3, so their detailed descriptions will be omitted for the sake of conciseness. If the ad response is received from the second client 220, the server 210 transmits the ad response to the first client 200 in step 660. In the same manner as in FIG. 3, for the ad response, an ad share/forward response message that includes information as described in Table 2 is used.

Also, the ad share/forward request message is not transmitted as a separate message in a separate step as in FIG. 3, but is transmitted when the first client 200 provides the metrics for the corresponding ad to the server 210 in step 610. That is, when the first client 200 provides the metrics for the corresponding ad to the server in the step 610, it provides the information intended to be delivered using the ad share/forward request message as well.

According to the present invention, the server can constantly recognize the ad status and the ad changing particulars, such as whether the ad has been delivered to another user and how the ad has been used, without individually checking the ad changing particulars. Also, since the server can easily recognize the ad status, it can measure the effect of the corresponding ad and easily perform billing appropriation.

According to the present invention, the server can easily track the ad changing particulars by providing the status information of the shared/forwarded ad to the server, and can perform the billing appropriation of the corresponding ad. Also, since the server can grasp the reactions to the users' ads, the ad effect measurement becomes possible, and a discriminated custom ad service can be provided.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A client method for sharing a shared/forwarded advertisement(ad) in an ad management system including a plurality of clients and a server, the client method comprising:
receiving an ad data from the server;
determining a particular one of the plurality of clients to be provided the received ad data; and
delivering a request message to the server, the request message including information of the received ad data and an identification of the particular client,
wherein the server transmits the ad data to the another client according to the request message.

2. The client method as claimed in claim 1, wherein the server transmits information of the client which transmits the ad data.

3. The client method as claimed in claim 1, wherein the request message including information of the received ad data and an identification of the particular client, information of the received ad data is the received ad data itself.

4. The client method as claimed in claim 1, wherein the each of clients represent ad-engines mounted on different terminals, and the server represents mobile advertising (MobAd) entities on the network.

5. The client method as claimed in claim 1, wherein the request message includes at least one of an item for identifying the type of the message, a message version item, an item representing the subject that has transmitted the request message, an item representing an identifier (ID) of a user who intends to deliver the ad, an item representing the name of the user who has requested the ad delivery, an item representing an object that has received the delivered ad, and an item representing the ad or ad metadata to be delivered.

6. The client method as claimed in claim 1, further comprising:
receiving a response message according to the request message from the server.

7. The client method as claimed in claim 6, wherein the response message includes at least one of an item representing the response message to the request message, an item for indicating the kind of the message, and an item representing status information including transmission success, failure, and reason for failure of the request message.

8. The client method as claimed in claim 1, wherein the request message is delivered together with metrics for the received ad when the metrics are provided to the server.

9. A client method for managing a shared/forwarded advertisement (ad) in an ad management system including at least one client and a server, the client method comprising:
receiving an ad data from the server;
delivering directly information of the received ad data to an another client; and
delivering a message to notify to the server whether delivering the received ad data to the another client. 10. The client method as claimed in claim 9, wherein delivering directly information of the received ad data to the another client, the client transmits the received ad data via the local-area wireless communications.

11. The client method as claimed in claim 9, wherein delivering directly information of the received ad data to an another client, the information of the received ad data is the received ad data itself from the server.

12. The client method as claimed in claim 9, wherein delivering a message to notify to the server whether delivering the received ad data to the another client, the message including an identification of the another client and the information of the ad data.

13. The client method as claimed in claim 9, wherein the each of clients represent ad-engines mounted on different terminals, and the server represents mobile advertising (MobAd) entities on the network.

14. The client method as claimed in claim 9, wherein the message includes at least one of an item for identifying the type of the message, a message version item, an item representing the subject that has transmitted the request message, an item representing an identifier (ID) of a user who intends to deliver the ad, an item representing the name of the user who has requested the ad delivery, an item representing an object that has received the delivered ad, and an item representing the ad or ad metadata to be delivered.

15. The client method as claimed in claim 9, further comprising:
receiving a response message according to the message from the server.

16. The client method as claimed in claim 15, wherein the response message includes at least one of an item representing the response message to the message, an item for indicating the kind of the message, and an item representing status information including transmission success, failure, and reason for failure of the message.

17. The client method as claimed in claim 9, wherein the message is delivered together with metrics for the received ad when the metrics are provided to the server.

18. A server method for providing a shared/forwarded advertisement (ad) in an ad management system including a plurality of clients and a server, the server method comprising:
transmitting an ad data to a particular client;
receiving a request message from the particular client, the request message including information about ad delivery to deliver a received ad data;
storing the information about the ad delivery from the request message, and transmitting a response message corresponding to the request message to the particular client; and
transmitting the corresponding ad using the information to another client.

19. The server method as claimed in claim 18, wherein the receiving a request message from the particular client, the request message including further an identification of another client to be designated from the particular client.

20. The server method as claimed in claim 18, wherein the transmitting the corresponding ad using the information to another client, the server transmits with the corresponding ad.

21. The server method as claimed in claim 18, wherein the server notify the another client what receiving the ad delivery from the particular client before the transmitting the corresponding ad using the information to another client.
